(19) United States
(12) Patent Application Publication
(10) Pub. No.: US 2015/0375168 A1
(43) Pub. Date: Dec. 31, 2015

(54) EXHAUST GAS TREATMENT METHOD, EXHAUST GAS TREATMENT DEVICE, AND EXHAUST GAS TREATMENT SYSTEM

(71) Applicant: MITSUBISHI HEAVY INDUSTRIES ENVIRONMENTAL & CHEMICAL ENGINEERING CO., LTD., Kanagawa (JP)

(72) Inventors: Takumi SUZUKI, Tokyo (JP); Masatoshi KATSUKI, Tokyo (JP); Tetsuya SAKUMA, Yokohama-shi (JP); Keita INOUE, Yokohama-shi (JP); Naohiro YAMADA, Yokohama-shi (JP); Taiji UCHIDA, Yokohama-shi (JP)

(21) Appl. No.: 14/767,913

(22) PCT Filed: Feb. 7, 2014
(86) PCT No.: PCT/JP2014/052968

§ 371 Date: Aug. 14, 2015

(30) Foreign Application Priority Data
Feb. 19, 2013 (JP) 2013-029866
May 1, 2013 (JP) 2013-096439

(51) Int. Cl. B01D 53/81; B01D 53/86; B01D 53/50; B01D 53/75; F01N 3/20; B01D 53/68

(52) U.S. Cl. CPC B01D 53/81; F01N 3/206; B01D 53/685; B01D 53/508; B01D 53/75; B01D 53/8631; B01D 2251/604; B01D 2253/102

(57) ABSTRACT

An exhaust gas treatment system provided with an exhaust gas treatment device, the exhaust gas treatment system having: a reaction unit for causing a gas purification agent and an acidic gas to react, the reaction unit being provided with a gas purification agent addition means for adding a gas purification agent to an exhaust gas containing the acidic gas and having a temperature of at least 190° C.; and a removal unit provided with a bag filter for removing the reaction product obtained by the reaction unit from the exhaust gas; the gas purification agent containing slaked lime having a specific surface area as measured by the BET method of at least of 25 m²/g and a pore volume as measured by the nitrogen desorption BJH method of at least 0.15 cm³/g. In this exhaust gas treatment system, an exhaust gas purification catalyst may be supported on the bag filter.

### TECHNICAL FIELD

The present invention relates to an exhaust gas treatment method, an exhaust gas treatment device, and an exhaust gas treatment system that removes an acidic gas in an exhaust gas using slaked lime.

Priority is claimed on Japanese Patent Application No. 2013-029866, filed Feb. 19, 2013, and Japanese Patent Application No. 2013-096439, filed May 1, 2013, the contents of which are incorporated herein by reference.

### BACKGROUND ART

Acidic gases, such as hydrogen chlorides and sulfur oxides (SOₓ), are contained in exhaust gases exhausted from boilers, incinerators, or the like. Since the acidic gases cause air pollution, it is necessary to perform the treatment of removing the acidic gases, on the exhaust gases. An example of an exhaust gas treatment system that treats an exhaust gas containing an acidic gas is illustrated in FIG. 11. The exhaust gas treatment system 5 has a temperature adjusting unit 10 that adjusts the temperature of an exhaust gas exhausted from an exhaust gas generating device A, a reaction unit 20 including slaked lime addition means (gas purification agent addition means) 21 for adding slaked lime (gas purification agent) to the exhaust gas, a removal unit 30 that removes a reaction product obtained by the reaction unit 20 from the exhaust gas, a reheater D that reheats the exhaust gas from which the reaction product has been removed, and a denitrification device B that performs denitrification treatment of the reheated exhaust gas.

As a method of removing the acidic gas in the exhaust gas, a method of adding the slaked lime to the exhaust gas to cause the slaked lime to react with the acidic gas using the slaked lime addition means 21, and then, supplying the exhaust gas to the removal unit 30 via a pipe 22, and removing the obtained reaction product using a bag filter or the like in the removal unit 30 has been widely adopted.

In the slaked lime used in the related art, as the temperature at which the slaked lime is made to react with the acidic gas becomes lower, the reactivity of the slaked lime becomes higher, and the removal rate of the acidic gas tends to become higher (PTLs 1 and 2). Therefore, in the exhaust gas treatment method of the related art, the slaked lime is caused to react with the acidic gas at 190° C. or lower.

### CITATION LIST

### Patent Literature

[PTL 1] Japanese Unexamined Patent Application Publication No. 11-248124

[PTL 2] Japanese Patent No. 3368751

### SUMMARY OF INVENTION

### Technical Problem

However, if the temperature at which slaked lime is caused to react with the acidic gas is made low, the acidic gas may condense and the liquid matter from the acidic gas may be created. Since the liquid matter from the acidic gas has high corrosiveness, the corrosion of a device that treats the exhaust gas may be caused. Additionally, since the temperature of the exhaust gas is a high temperature of 220° C. or higher, the treatment of lowering the temperature of the exhaust gas is required in order to set the temperature, at which the slaked lime is caused to react with the acidic gas, to be lower than 190° C. Therefore, as illustrated in FIG. 11, the temperature adjusting unit 10 that adjusts the temperature of the exhaust gas is provided. Moreover, when the denitrification treatment on the exhaust gas from which the acidic gas is removed is performed in the denitrification device B, it is necessary to reheat the exhaust gas using the reheater D in order to bring about a temperature (210° C. or higher) suitable for a denitrification reaction. Therefore, the temperature is again raised after being lowered first, and the amount of energy consumed tends to increase.

Meanwhile, if the related-art slaked lime is used, the reactivity becomes insufficient if the temperature at which the slaked lime is caused to react with the acidic gas is made high. Therefore, the amount of slaked lime used tends to increase. The invention provides an exhaust gas treatment method, an exhaust gas treatment device, and an exhaust gas treatment system that can obtain sufficient acidic gas removal performance without increasing the amount of slaked lime used, even when the temperature at which the slaked lime is caused to react with the acidic gas is made high (specifically, 190° C. or higher).

### Solution to Problem

According to a first aspect of the invention, there is provided an exhaust gas treatment method including: a reaction process of adding slaked lime to an exhaust gas containing acidic gases and causing the slaked lime to react with the acidic gases at 190° C. or higher; and a removal process of removing a reaction product obtained by the reaction process from the exhaust gas, using a bag filter. The specific surface area of the slaked lime measured by the BET method is equal to or greater than 25 m²/g and the pore volume of the slaked lime measured by the nitrogen desorption BJH method is equal to or greater than 0.15 cm³/g.

In the exhaust gas treatment method, an exhaust gas purification catalyst may be supported on the bag filter.

In the exhaust gas treatment method, activated carbon may be added together with the slaked lime in the reaction process.

According to a second aspect of the invention, there is provided and exhaust gas treatment device including: a reaction unit that includes gas purification agent addition means for adding a gas purification agent to an exhaust gas containing an acidic gas and having a temperature of 190° C. or higher and that causes the gas purification agent to react with the acidic gas; and a removal unit including a bag filter that removes a reaction product obtained by the reaction unit from the exhaust gas. The gas purification agent contains slaked lime of which the specific surface area measured by the BET method is equal to or greater than 25 m²/g and the pore volume measured by the nitrogen desorption BJH method is equal to or greater than 0.15 cm³/g.

In the exhaust gas treatment device, the exhaust gas purification catalyst may be supported on the bag filter.

In the exhaust gas treatment device, the gas purification agent may further contain activated carbon.

According to a third aspect of the invention, there is provided an exhaust gas treatment system including: a reaction unit that includes gas purification agent addition means for adding a gas purification agent to an exhaust gas containing an acidic gas and having a temperature of 190° C. or higher and that causes the gas purification agent to react with the acidic gas; and a removal unit including a bag filter that removes a reaction product obtained by the reaction unit from the exhaust gas. The gas purification agent contains slaked lime of which the specific surface area measured by the BET method is equal to or greater than 25 m²/g and the pore volume measured by the nitrogen desorption BJH method is equal to or greater than 0.15 cm³/g.

The exhaust gas treatment system may further include a temperature adjusting unit that adjusts the temperature of the exhaust gas to 190° C. or higher in a preceding stage of the reaction unit.

The exhaust gas treatment system may further include a denitrification device that performs denitrification treatment of the exhaust gas in a subsequent stage of the removal unit.

The exhaust gas treatment system may further include a reheater that reheats the exhaust gas between the removal unit and the denitrification device.

In the exhaust gas treatment system, the exhaust gas purification catalyst may be supported on the bag filter.

In the exhaust gas treatment system, the gas purification agent may further contain activated carbon.

### Advantageous Effects of Invention

It was found that the slaked lime of which the specific surface area measured by the BET method measured is equal to or greater than 25 m²/g, and the pore volume measured by the nitrogen desorption BJH method is equal to or greater than 0.15 cm³/g has a high activity with the acidic gas. In the above-described exhaust gas treatment method, exhaust gas treatment device, and exhaust gas treatment system using this slaked lime, sufficient acidic gas removal performance can be obtained without increasing the amount of slaked lime used, even when the temperature at which the slaked lime is caused to react with the acidic gas is set to a temperature of 190° C. or higher.

In the above-described exhaust gas treatment method, exhaust gas treatment device, and exhaust gas treatment system, if a bag filter on which an exhaust gas purification catalyst is supported is used as the above bag filter, it is possible to remove dioxins or nitrogen oxides contained in the exhaust gas. Therefore, the exhaust gas can be further purified.

Additionally, in the exhaust gas treatment method, the exhaust gas treatment device, and the exhaust gas treatment system, mercury in the exhaust gas can be removed if the activated carbon is added together with the slaked lime.

### BRIEF DESCRIPTION OF DRAWINGS

FIG. 1 is a schematic view illustrating an exhaust gas treatment device that constitutes a first embodiment of an exhaust gas treatment system of the invention.

FIG. 2 is a schematic view illustrating an example of the exhaust gas treatment system of the first embodiment.

FIG. 3 is a schematic view illustrating another example of the exhaust gas treatment system of the first embodiment.

FIG. 4 is a schematic view illustrating an exhaust gas treatment device that constitutes a second embodiment of an exhaust gas treatment system of the invention.

FIG. 5 is a schematic view illustrating an example of the exhaust gas treatment system of the second embodiment.

FIG. 6 is a schematic view illustrating another example of the exhaust gas treatment system of the second embodiment.

FIG. 7 is a graph illustrating a desulfurization rate with respect to the specific surface area of slaked lime measured by the BET method.

FIG. 8 is a graph illustrates the desulfurization rate with respect to the pore volume of the slaked lime measured by the nitrogen desorption BJH method.

FIG. 9 is a graph illustrating a salt rejection rate with respect to reaction temperature.

FIG. 10 is a graph illustrating the desulfurization rate with respect to reaction temperature.

FIG. 11 is a schematic view illustrating an example of an exhaust gas treatment system in the related art.

### DESCRIPTION OF EMBODIMENTS

### First Embodiment

A first embodiment of an exhaust gas treatment system of the invention will be described.

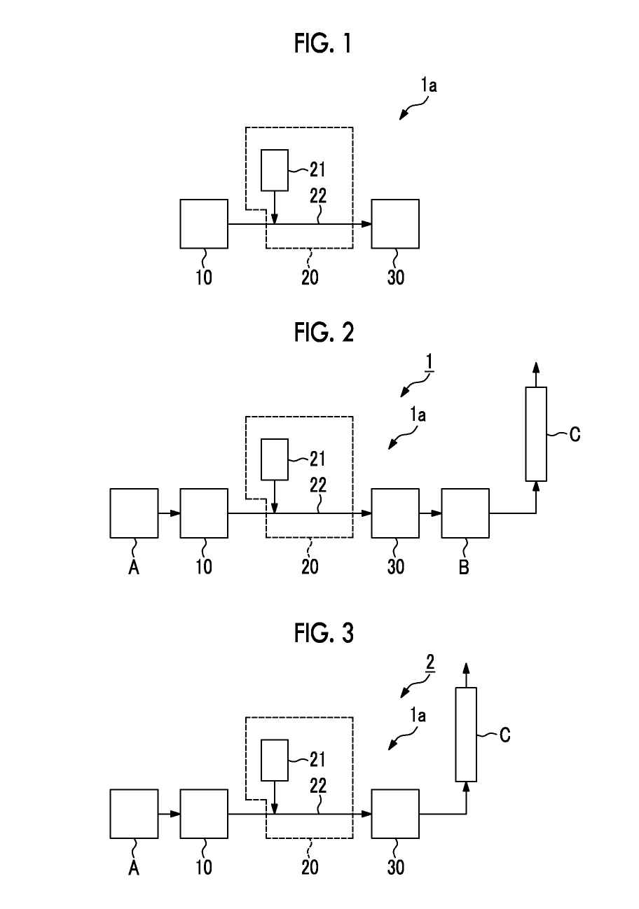

The exhaust gas treatment system of the present embodiment has an exhaust gas treatment device 1a illustrated in FIG. 1. The exhaust gas treatment device 1a of the present embodiment is a device that has a temperature adjusting unit 10, a reaction unit 20, and a removal unit 30, treats an exhaust gas containing an acidic gas, and removes the acidic gas from the exhaust gas.

The above exhaust gas includes gas exhausted from various incinerators, such as municipal waste incinerators, industrial waste incinerators, or sewage-sludge incinerators, boilers, diesel engines, or the like.

The acidic gas contained in the above exhaust gas includes hydrogen chlorides, sulfur oxides, hydrogen fluoride, or the like.

The temperature adjusting unit 10 in the present embodiment adjusts the temperature of the exhaust gas containing the acidic gas to a temperature suitable for exhaust gas treatment in a range of 190° C. or higher. It is preferable that the temperature of the exhaust gas is adjusted to be higher than 200° C. and lower than 240° C. by the temperature adjusting unit 10. Additionally, it is more preferable that the temperature of the exhaust gas is adjusted to be equal to or higher than 220° C. and lower than 240° C. Moreover, it is more preferable that the temperature of the exhaust gas is adjusted to be equal to or higher than 220° C. and equal to or lower than 235° C. If the adjusted temperature of the exhaust gas is lower than 190° C., the acidic gas may condense to generate corrosive liquid matter. Additionally, when the exhaust gas having passed through the removal unit 30 is reheated, the amount of energy required for heating tends to increase.

Usually, since the exhaust gas is exhausted at high temperature, a cooling device that lowers the temperature of the exhaust gas is used as the temperature adjusting unit 10. The cooling device includes devices using a heat exchanger, or the like.

The reaction unit 20 in the present embodiment includes slaked lime addition means 21 for adding slaked lime to the exhaust gas. The reaction unit 20 causes the slaked lime to react with the acidic gas of which the temperature has been adjusted to the above range by the temperature adjusting unit 10.

In the exhaust gas treatment device 1a in the present embodiment, the slaked lime addition means 21 is connected to a pipe 22 that connects the temperature adjusting unit 10 and the removal unit 30 together. Specifically, the reaction unit 20 is a portion ranging from the portion of the pipe 22 to which the slaked lime is added by the slaked lime addition means 21 to the removal unit 30. However, a reaction between the slaked lime and the acidic gas occurs even in the removal unit 30. Existing devices or existing means can be used as the slaked lime addition means 21.

Additionally, in the reaction unit 20, activated carbon may be added to the exhaust gas together with the slaked lime for the purpose of removing mercury in the exhaust gas.

The slaked lime to be used in the present embodiment is particles containing Ca(OH)₂ as a main component. The specific surface area (hereinafter referred to as “BET specific surface area”) of the slaked lime measured by the BET method is equal to or greater than 25 m²/g, and the pore volume (hereinafter referred to as “pore volume”) of the slaked lime measured by the nitrogen desorption BJH method is equal to or greater than 0.15 cm³/g. If the BET specific surface area is lower than the lower limit (25 m²/g) and the pore volume is lower than the lower limit (0.15 cm³/g), reactivity with respect to the acidic gas at 190° C. or higher degrades.

Meanwhile, it is preferable that the BET specific surface area of the slaked lime is equal to or lower than 60 m²/g from a viewpoint of availability. It is preferable that the pore volume is equal to or lower than 0.3 cm³/g.

The BET specific surface area is a value that is measured and obtained as the slaked lime adsorbs nitrogen at 77 K after the slaked lime is outgassed. The pore volume is a value that is measured and obtained by absorbing the slaked lime at 77 K and desorbing nitrogen after the slaked lime is outgassed. The BET specific surface area and the pore volume can be measured by commercially available analysis instruments. The analysis instruments include, for example, ASAP series of specific surface area and pore distribution analysis instruments or the like manufactured by Micromeritics Instrument Corporation.

Alkali metals may be contained in a range of 0.2 mass % to 3.5 mass % in the slaked lime. The alkali metals include sodium, potassium, or lithium. If the alkali metals are contained in this range in the slaked lime, acidic gas removal performance becomes higher.

It is preferable that the mean particle diameter of the slaked lime is 5 μm to 12 μm. Additionally, it is more preferable that the mean particle diameter of the slaked lime is 7 μm to 10 μm. Here, the mean particle diameter is a value measured by a laser particle size measuring device or SEM observation.

The removal unit 30 in the present embodiment includes a bag filter that removes a reaction product obtained by the reaction unit 20 from the exhaust gas. In the removal unit 30, the exhaust gas containing the reaction product is supplied to the bag filter, and the reaction product is trapped by the bag filter. Accordingly, the acidic gas content of the exhaust gas passed through the bag filter decreases.

The reaction product trapped by the bag filter is periodically brushed off, and is removed from the removal unit 30.

The bag filter used for the removal unit 30 is a so-called “filter cloth”. The filter cloth is formed of cloth woven by weaving, such as twill weaving, satin weaving, and plain weaving. It is preferable that the mass density of the cloth is 600 g/m² to 1200 g/m². If the mass density is equal to or greater than the lower limit (600 g/m²), the reaction product can be sufficiently trapped. If the mass density is equal to or lower than the upper limit (1200 g/m²), clogging can be suppressed.

Fibers that constitute the bag filter include, for example, glass fibers, polyfluoroethylene-based fibers, polyester-based fibers, polyamide-based fibers, polyphenylene sulfide-based fibers, or the like. Among the above fibers, glass fibers and polyfluoroethylene-based fibers are preferable in that heat resistance is high. It is preferable that the diameter of the fibers is 3 μm to 15 μm.

It is preferable that an exhaust gas purification catalyst is supported on the bag filter. If the exhaust gas purification catalyst is supported on the bag filter, the exhaust gas can be further purified.

If the exhaust gas purification catalyst supported on the bag filter has nitrogen oxide decomposition performance, the content of nitrogen oxides in the exhaust gas becomes low, and denitrification treatment other than with the bag filter can be omitted.

If the exhaust gas purification catalyst supported on the bag filter has dioxin decomposition performance, the dioxin content in the exhaust gas becomes low. Generally, as the temperature is made higher, dioxin removal performance tends to become lower. However, if an exhaust gas purification catalyst having dioxin decomposition performance is supported on the bag filter, the same dioxin removal performance as that in a case where the temperature is lower than 190° C. is obtained even if the temperature is made to be equal to or higher than 190° C.

The exhaust gas purification catalyst supported on the bag filter is a catalyst consisting of a support consisting of single or complex oxides and an active ingredient consisting of oxides. The support contains at least one or more kinds of element selected from titanium (Ti), silicon (Si), aluminum (Al), zirconium (Zr), phosphorus (P), and boron (B). The active ingredient includes at least one kind among oxides of vanadium (V), tungsten (W), molybdenum (Mo), niobium (Nb), and tantalum (Ta).

As the support, it is preferable to use at least titanium oxides.

As the active ingredient, it is preferable to use at least vanadium oxides. All of the above active ingredients have redox capacity, and can oxidatively decompose dioxins. Additionally, all of the above active ingredients can reduce nitrogen oxides in the presence of a reducing agent. Among the above active ingredients, vanadium oxides particularly have excellent redox capacity.

The composition of the exhaust gas purification catalyst is not particularly limited. When the active ingredient is one ingredient of vanadium pentoxide, it is preferable that the active ingredient has 1 to 20 parts by weight with respect with respect to 100 parts by weight of the support.

When the active ingredients are two ingredients of vanadium pentoxide and tungsten trioxide, it is preferable that vanadium pentoxide has 1 to 10 parts by weight, and tungsten trioxide has 2 parts by weight to 25 parts by weight with respect to 100 parts by weight of the support.

It is preferable that the amount of the exhaust gas purification catalyst supported on the bag filter is 1 g/m² to 500 g/m². Additionally, it is preferable that the amount of the exhaust gas purification catalyst supported on the bag filter is 50 g/m² to 450 g/m². If the amount of the supported exhaust gas purification catalyst is equal to or greater than the lower limit (1 g/m²), sufficiently high exhaust gas purification is obtained, and if the amount of the supported exhaust gas purification catalyst is equal or lower than the upper limit (500 g/m²), the clogging of the bag filter can be prevented.

A first example of an exhaust gas treatment system using the above exhaust gas treatment device 1a will be described with reference to FIG. 2.

The exhaust gas treatment system 1 of the present example includes the exhaust gas treatment device 1a and a denitrification device B that performs denitrification treatment of the exhaust gas treated in the exhaust gas treatment device 1a, and does not include a reheater. The exhaust gas denitrified by the denitrification device B is emitted into the atmospheric air from a chimney C.

An exhaust gas treatment method using the above exhaust gas treatment system 1 will be described. This exhaust gas treatment method has a temperature adjustment process, a reaction process, a removal process, and a denitrification process. This exhaust gas treatment method treats the exhaust gas exhausted from an exhaust gas generating device A of the exhaust gas treatment system 1 illustrated in FIG. 2, and performs denitrification treatment in the denitrification device B.

The temperature adjustment process is a process of adjusting the temperature of the exhaust gas exhausted from the exhaust gas generating device A to a suitable temperature of 190° C. or higher in the temperature adjusting unit 10. As described above, it is preferable that the temperature of the exhaust gas is adjusted to be higher than 200° C. and lower than 240° C. It is more preferable that the temperature of the exhaust gas is adjusted to be equal to or higher 220° C. and lower than 240° C. It is more preferable that the temperature of the exhaust gas is adjusted to be equal to or higher than 220° C. and equal to or lower than 235° C.

The reaction process is a process of, in the reaction unit 20, adding the slaked lime to the exhaust gas of which the temperature is adjusted by the temperature adjustment process and causing the slaked lime to react with the acidic gas. In the present example, since the temperature of the exhaust gas is adjusted to be equal to or higher than 190 degrees C., the reaction between the slaked lime and the acidic gas proceeds inside the pipe 22 and the removal unit 30 after the slaked lime is added into the pipe 22 through which the exhaust gas passes by the slaked lime addition means 21.

In the reaction process, activated carbon may be added to the exhaust gas together with the slaked lime for the purpose of removing mercury in the exhaust gas.

The removal process is a process of removing a reaction product obtained by the reaction process from the exhaust gas using the bag filter. Here, the reaction product includes CaSO₄ when sulfur oxides are contained as the acidic gas. The reaction product includes CaCl₂ or the like when hydrogen chloride is contained as the acidic gas.

Specifically, in the removal process, the reaction product contained in the exhaust gas is trapped by the bag filter of the removal unit 30, and the exhaust gas is filtered by the bag filter. Accordingly, the content of the acidic gas in the exhaust gas is reduced.

The reaction product trapped by the bag filter is periodically brushed off from the a bag filter and is collected as dust.

The exhaust gas after the removal process is sent to the denitrification device B, and is subjected to denitrification treatment. The exhaust gas denitrified by the denitrification device B is emitted into the atmospheric air from the chimney C.

In the denitrification process, NOx contained in the exhaust gas is decomposed and removed, for example, using the denitrification device B including a reactor filled with a denitrification catalyst. In the denitrification process, reducing agents, such as ammonia, may be used if necessary.

A second example of an exhaust gas treatment system using the above exhaust gas treatment device 1a will be described with reference to FIG. 3.

An exhaust gas treatment system 2 of the present example includes the exhaust gas treatment device 1a, and does not include the denitrification device and the reheater. The exhaust gas exhausted from the exhaust gas treatment device 1a is emitted into the atmospheric air from the chimney C.

An exhaust gas treatment method using the above exhaust gas treatment system 2 will be described. This exhaust gas treatment method has the temperature adjustment process, the reaction process, and the removal process. This exhaust gas treatment method treats the exhaust gas exhausted from the exhaust gas generating device A of the exhaust gas treatment system 2 illustrated in FIG. 3, and then sends the treated exhaust gas to the chimney C without passing the exhaust gas through the denitrification device, and emits the exhaust gas after the removal process into the atmospheric air from the chimney C. The temperature adjustment process, the reaction process, and the removal process in the present example are the same as those of the above first example.

When the content of nitrogen oxides in the exhaust gas is low or when the bag filter that supports the exhaust gas purification catalyst having nitrogen oxide decomposition performance is used, the method of the present example is applied.

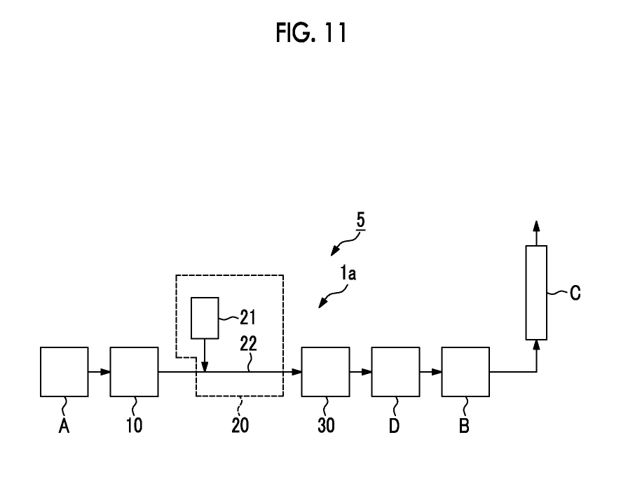

A third example of an exhaust gas treatment system using the above exhaust gas treatment device 1a will be described with reference to FIG. 11. The exhaust gas treatment system 5 of the present example is the same as those of exhaust gas treatment systems in the related art except that slaked lime of which the specific surface area is equal to or greater than 25 m²/g and the pore volume is equal to or greater than 0.15 cm³/g is used. That is, the exhaust gas treatment system 5 of the present example includes the exhaust gas treatment device 1a, a reheater D that reheats the exhaust gas passed through the exhaust gas treatment device 1a, and the denitrification device B that performs denitrification treatment of the reheated exhaust gas. The exhaust gas denitrified by the denitrification device B is emitted into the atmospheric air from the chimney C.

An exhaust gas treatment method using the above exhaust gas treatment system 5 will be described.

This exhaust gas treatment method has a temperature adjustment process, a reaction process, a removal process, a reheating process, and a denitrification process. This exhaust gas treatment method treats the exhaust gas exhausted from the exhaust gas generating device A of the exhaust gas treatment system 5 illustrated in FIG. 11, and then, reheats the treated exhaust gas, and performs denitrification treatment of the reheated exhaust gas using the denitrification device B.

The temperature adjustment process, the reaction process, the removal process, and the denitrification process in the present example are the same as those of the above first example.

Since the slaked lime used in the above exhaust gas treatment device 1a and the above exhaust gas treatment method has a large specific surface area and a large pore volume, the reactivity thereof with the acidic gas is high. Therefore, in slaked lime used in the related art, sufficiently high acidic gas removal performance can be secured even in a temperature region where reactivity also becomes low. Therefore, sufficient acidic gas removal performance can be obtained without increasing the amount of slaked lime used, even when the temperature at which the slaked lime is caused to react with the acidic gas is set to a temperature of 190° C. or higher.

In the present embodiment, as described above, the slaked lime is caused to react with the acidic gas at high temperature. Therefore, the liquid matter from the acidic gas with high corrosiveness is not easily created, and the corrosion of the exhaust gas treatment device 1a can be prevented. Additionally, when denitrification treatment is performed on the exhaust gas after the removal process, the amount of energy for reheating in the reheater D can be further reduced than that in a related-art method using slaked lime of which the specific surface area is smaller than 25 m²/g and the pore volume is smaller than 0.15 cm³/g. Moreover, the reheating as in the above first example and the above second example can be omitted depending on denitrification treatment conditions.

Generally, when hydrogen chloride is contained in the acidic gas, a reaction between the slaked lime and sulfur oxides readily proceeds in the reaction between the slaked lime and the acidic gas. As a result, since desulfurization performance becomes higher, it is preferable that hydrogen chloride is also present in the acidic gas. However, since the slaked lime used in the present embodiment has high reactivity, even if hydrogen chloride is not present, the reactivity of the slaked lime with the sulfur oxides can be high and high desulfurization performance can be achieved. Therefore, the slaked lime is suitable for desulfurization of the exhaust gas from industrial waste incinerators where hydrogen chloride concentration in the exhaust gas is low and the exhaust gas from sewage-sludge incinerators.

### Second Embodiment

A second embodiment of the exhaust gas treatment system of the invention will be described.

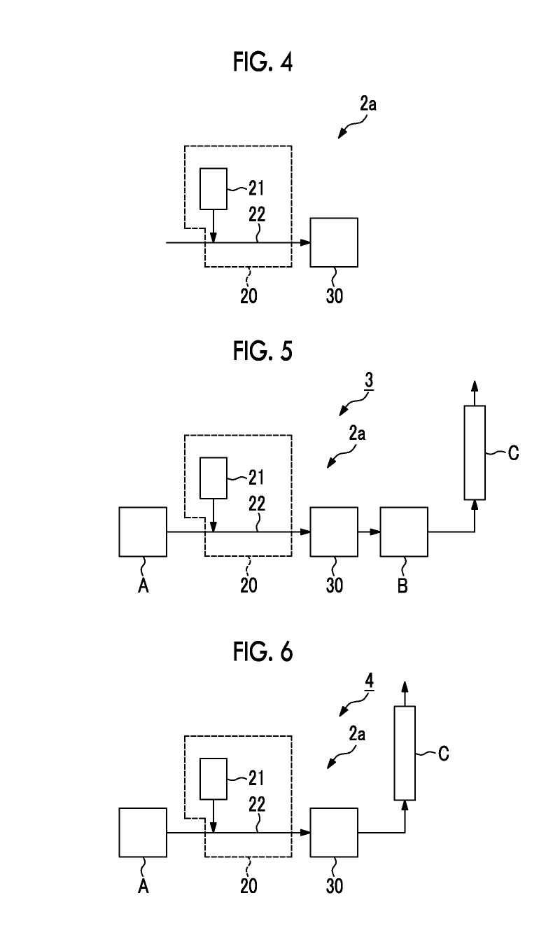

The exhaust gas treatment system of the present embodiment has an exhaust gas treatment device 2a illustrated in FIG. 4. The exhaust gas treatment device 2a of the present embodiment is the same as that of the exhaust gas treatment device 1a of the first embodiment except for not having the temperature adjusting unit. The exhaust gas treatment device 2a of the present embodiment has the reaction unit 20 and the removal unit 30. Therefore, also in the present embodiment, the above slaked lime is caused to react with the acidic gas in the exhaust gas, and the reaction product is trapped by the bag filter.

The second embodiment is applied to a case where the temperature of the exhaust gas may not be adjusted by the temperature adjusting unit, that is, a case where the temperature of the exhaust gas exhausted from the exhaust gas generating device is equal to or higher than 190° C.

A first example of an exhaust gas treatment system using the above exhaust gas treatment device 2a will be described with reference to FIG. 5.

The exhaust gas treatment system 3 of the present example includes the exhaust gas treatment device 2a and the denitrification device B that performs denitrification treatment of the exhaust gas treated in the exhaust gas treatment device 2a, and does not include the reheater. The exhaust gas denitrified by the denitrification device B is emitted into the atmospheric air from the chimney C.

An exhaust gas treatment method using the above exhaust gas treatment system 3 will be described.

This exhaust gas treatment method has the reaction process, the removal process, and the denitrification process. This exhaust gas treatment method treats the exhaust gas exhausted from the exhaust gas generating device A of the exhaust gas treatment system 3 illustrated in FIG. 5, and performs denitrification treatment in the denitrification device B.

That is, in the reaction unit 20, the slaked lime is added and the slaked lime is caused to react with the acidic gas, without adjusting the temperature of the exhaust gas exhausted from the exhaust gas generating device A, in the temperature adjusting unit. Next, in the removal process, the reaction product formed in the reaction process is removed from the exhaust gas, using the bag filter of the removal unit 30, and the content of the acidic gas in the exhaust gas is reduced. Then, the exhaust gas in which the content of the acidic gas has been reduced is subjected to denitrification treatment using the denitrification device B, and the exhaust gas subjected to the denitrification treatment is emitted into the atmospheric air from the chimney C.

A second example of an exhaust gas treatment system using the above exhaust gas treatment device 2a will be described with reference to FIG. 6.

An exhaust gas treatment system 4 of the present example includes the exhaust gas treatment device 2a, and does not include the denitrification device and the reheater. The exhaust gas exhausted from the exhaust gas treatment device 2a is emitted into the atmospheric air from the chimney C.

An exhaust gas treatment method using the above exhaust gas treatment system 4 will be described.

This exhaust gas treatment method has the reaction process and the removal process. This exhaust gas treatment method treats the exhaust gas exhausted from the exhaust gas generating device A of the exhaust gas treatment system 4 illustrated in FIG. 6, and then sends the treated exhaust gas to the chimney C without passing the exhaust gas through the denitrification device, and emits the exhaust gas after the removal process into the atmospheric air from the chimney C. The reaction process and the removal process in the present example are the same as those of the above first example.

When the content of nitrogen oxides in the exhaust gas is low or when the bag filter that support the exhaust gas purification catalyst having nitrogen oxide decomposition performance is used, the method of the present example is applied.

Also in the exhaust gas treatment systems 3 and 4 and the exhaust gas treatment method of the present embodiment, similar to the first embodiment, sufficient acidic gas removal performance can be obtained without increasing the amount of slaked lime used, even when the temperature at which the slaked lime is caused to react with the acidic gas is set to a temperature of 190° C. or higher.

In addition to this, in the present embodiment, the acidic gas in the exhaust gas is caused to react with the slaked lime without adjusting the temperature of the exhaust gas. However, the configuration of the device that removes the acidic gas can be simplified.

### EXAMPLES

Removal treatment of acidic gases was performed on a simulated exhaust gas manufactured to contain 400 ppm of HCL and 50 ppm of SO₂ using a plurality of kinds of slaked lime in which the BET specific surface area and the pore volume varied. Specifically, the slaked lime was added to the simulated exhaust gas, HCl and SO₂ were caused to react with the slaked lime at 220° C., and the obtained reaction product was trapped by the bag filter (mass density: 900 g/m²) and removed from the exhaust gas. The concentrations of HCl and SO₂ in the exhaust gas after the acidic gas removal treatment were measured, and the salt rejection rate (HCl removal rate) and the desulfurization rate (SO₂ removal rate) were obtained.

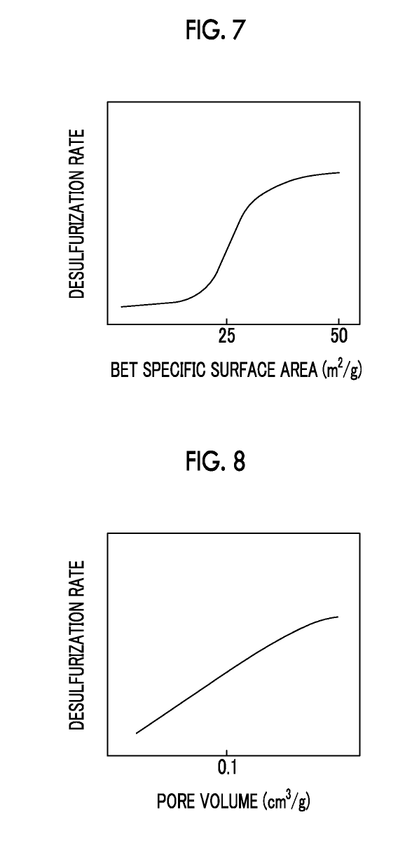

A graph in a case where the horizontal axis represents the BET specific surface area and the vertical axis represents the desulfurization rate is illustrated in FIG. 7. A graph in a case where the horizontal axis represents the pore volume and the vertical axis represents the desulfurization rate is illustrated in FIG. 8.

It can be seen from FIG. 7 that the desulfurization rate is improved if the BET specific surface area of the slaked lime becomes equal to or greater than 25 m²/g. It can be seen from FIG. 8 that the desulfurization rate is improved if the pore volume of the slaked lime becomes equal to or greater than 0.15 cm³/g.

As an example of the invention, HCl and SO₂ were caused to react with slaked lime by adding the slaked lime (slaked lime used in the present embodiment), in which the BET specific surface area is 40 m²/g and the pore volume is 0.3 cm³/g, to a simulated exhaust gas made to contain 400 ppm of HCl and 50 ppm of SO₂. Additionally, as a comparative example, HCl and SO₂ were caused to react with slaked lime by adding the slaked lime (slaked lime used in the related art), in which the BET specific surface area is 15 m²/g and the pore volume is 0.07 cm³/g, to a simulated exhaust gas made to contain 400 ppm of HCl and 50 ppm of SO₂ Specifically, reaction products obtained by these reactions were trapped by the bag filter (mass density: 900 g/m²) and removed from the exhaust gas.

The reaction temperature conditions in the case of the above acidic gas removal treatment were changed in step of 10° C. between 150° C. and 220° C., the concentrations of HCl and SO₂ in the exhaust gas after the acidic gas removal treatment were measured, respectively, and the salt rejection rate (HCl removal rate) and the desulfurization rate (SO₂ removal rate) were obtained.

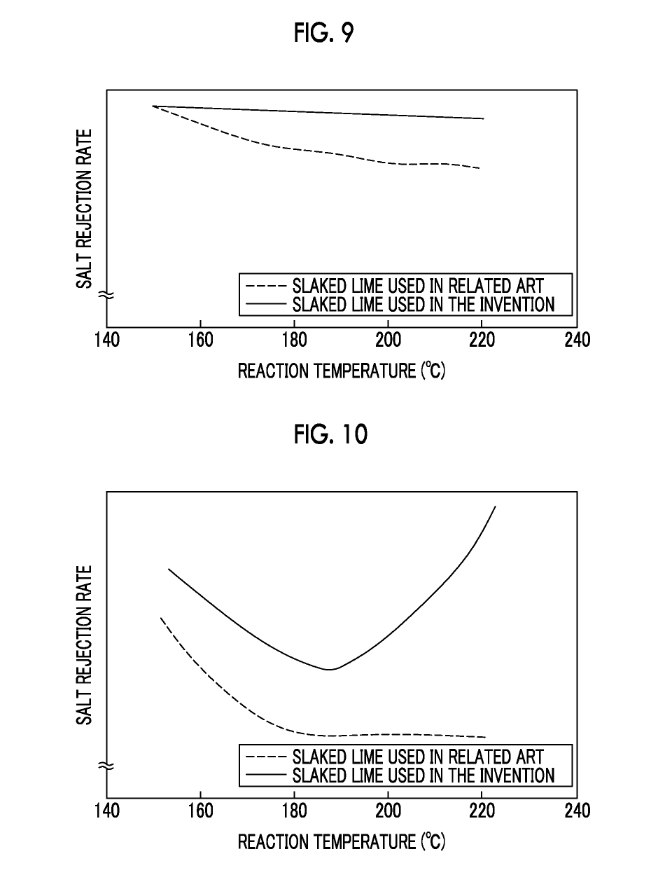

A graph in a case where a horizontal axis represents reaction temperature and a vertical axis represents the salt rejection rate is illustrated in FIG. 9. A graph in a case where a horizontal axis represents the reaction temperature and a vertical axis represents the desulfurization rate is illustrated in FIG. 10.

It can be seen from FIG. 9 that, in the slaked lime used in the related art, the salt rejection rate falls if the reaction temperature becomes high, whereas, in the slaked lime used in the example of the invention, the salt rejection rate can be maintained even if the reaction temperature becomes high. It can be seen from FIG. 10 that, in the slaked lime used in the related art, the desulfurization rate falls if the reaction temperature becomes high, whereas, in the slaked lime used in the example of the invention, the desulfurization rate becomes the minimum if the reaction temperature is near 185° C., and on the contrary the desulfurization rate becomes high if the reaction temperature becomes equal to or higher 190° C.

### INDUSTRIAL APPLICABILITY

According to the exhaust gas treatment method, the exhaust gas treatment device, and the exhaust gas treatment system, the slaked lime of which the specific surface area measured by the BET method is equal to or greater than 25 m²/g and the pore volume measured by the nitrogen desorption BJH method is equal to or greater than 0.15 cm³/g is used. Accordingly, even if the temperature at which the slaked lime is caused to react with the acidic gas is made high (specifically, equal to or higher than 190° C.), sufficient acidic gas removal performance can be obtained without increasing the amount of slaked lime used.

### REFERENCE SIGNS LIST

1, 2, 3, 4, 5: EXHAUST GAS TREATMENT SYSTEM
1a, 2a: EXHAUST GAS TREATMENT DEVICE
10: TEMPERATURE ADJUSTING UNIT
20: REACTION UNIT
21: SLAKED LIME ADDITION MEANS (GAS PURIFICATION AGENT ADDITION MEANS)
30: REMOVAL UNIT
A: EXHAUST GAS GENERATING DEVICE
B: DENITRIFICATION DEVICE
C: CHIMNEY
D: REHEATER

1. An exhaust gas treatment method comprising:
a reaction process of adding slaked lime to an exhaust gas containing acidic gases and causing the slaked lime to react with the acidic gases at 190° C. or higher; and
a removal process of removing a reaction product obtained by the reaction process from the exhaust gas, using a bag filter,
wherein the specific surface area of the slaked lime measured by the BET method is equal to or greater than 25 m²/g and the pore volume of the slaked lime measured by the nitrogen desorption BJH method is equal to or greater than 0.15 cm³/g.

2. The exhaust gas treatment method according to claim 1,
wherein an exhaust gas purification catalyst is supported on the bag filter.

3. The exhaust gas treatment method according to claim 1,
wherein activated carbon is added together with the slaked lime in the reaction process.

4. An exhaust gas treatment device comprising:
a reaction unit that includes gas purification agent addition means for adding a gas purification agent to an exhaust gas containing an acidic gas and having a temperature of 190° C. or higher and that causes the gas purification agent to react with the acidic gas; and
a removal unit including a bag filter that removes a reaction product obtained by the reaction unit from the exhaust gas,
wherein the gas purification agent contains slaked lime of which the specific surface area measured by the BET method is equal to or greater than 25 m²/g and the pore volume measured by the nitrogen desorption BJH method is equal to or greater than 0.15 cm³/g.

5. The exhaust gas treatment device according to claim 4,
wherein the exhaust gas purification catalyst is supported on the bag filter.

6. The exhaust gas treatment device according to claim 4,
wherein the gas purification agent further contains activated carbon.

7. An exhaust gas treatment system comprising:
a reaction unit that includes gas purification agent addition means for adding a gas purification agent to an exhaust gas containing an acidic gas and having a temperature of 190° C. or higher and that causes the gas purification agent to react with the acidic gas; and
a removal unit including a bag filter that removes a reaction product obtained by the reaction unit from the exhaust gas,
wherein the gas purification agent contains slaked lime of which the specific surface area measured by the BET method is equal to or greater than 25 m²/g and the pore volume measured by the nitrogen desorption BJH method is equal to or greater than 0.15 cm³/g.

8. The exhaust gas treatment system according to claim 7, further comprising:
a temperature adjusting unit that adjusts the temperature of the exhaust gas to 190° C. or higher in a preceding stage of the reaction unit.

9. The exhaust gas treatment system according to claim 7, further comprising:
a denitrification device that performs denitrification treatment of the exhaust gas in a subsequent stage of the removal unit.

10. The exhaust gas treatment system according to claim 9, further comprising:
a reheater that reheats the exhaust gas between the removal unit and the denitrification device.

11. The exhaust gas treatment system according to claim 7,
wherein the exhaust gas purification catalyst is supported on the bag filter.

12. The exhaust gas treatment system according to claim 7,
wherein the gas purification agent further contains activated carbon.
